(19) United States
(12) Patent Application Publication
(10) Pub. No.: US 2003/0029765 A1
(43) Pub. Date: Feb. 13, 2003

(54) Composite kinematic coupling

(76) Inventors: Sanjiv M. Bhatt, Minnetonka, MN (US); Shawn D. Eggum, Lonsdale, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 10/212,483

(22) Filed: Aug. 5, 2002

Related U.S. Application Data
(63) Continuation-in-part of application No. 09/317,989, filed on May 25, 1999, now Pat. No. 6,428,729.
(60) Provisional application No. 60/087,205, filed on May 28, 1998.
(60) Provisional application No. 60/333,166, filed on Nov. 27, 2001.

(51) Int. Cl. B65D 85/48; B29C 45/14

(52) U.S. Cl. 206/454; 264/259; 264/274; 156/73.1; 264/328.8; 206/711; 211/41.18

(57) ABSTRACT

The kinematic coupling of the present invention may comprise a wafer carrier or carrier base plate comprising a first material. The base plate or carrier is provided with a contact component comprising a second material having a lower co-efficient of friction than the first material. The contact component may be provided to the base plate or directly to the bottom of a wafer carrier as part of an overmolding, snap-in-place, staking, ultrasonic weld or adhesive operation and may additionally be held in place by mechanical interlocking of the respective components. The method of manufacturing may include providing a contact component comprised of a first material to a carrier component comprised of a second material via one or more of the processes listed above, wherein the second material has a higher coefficient of friction than the first.

### CROSS-REFERENCE TO RELATED APPLICATION

The present application claims benefit of the priority date of provisional application No. 60/333,166, filed Nov. 14, 2001, and is a continuation-in-part application of U.S. patent application Ser. No. 09/317,989, filed on May, 25, 1999, now U.S. Pat. No. 6,428,729, which claims benefit of U.S. Provisional Application Serial No. 60/087,205, filed May 28, 1998. Each of these references is hereby incorporated in their entirety herein by reference.

### FIELD OF THE INVENTION

The present invention generally pertains to a wafer carrier designed for supporting, constraining, storing and precisely positioning semi-conductor wafer disks for use in the production of integrated circuits. More specifically, the invention pertains to interface couplings for aligning wafer carriers and method for same.

### BACKGROUND OF THE INVENTION

The manufacturing process for transforming wafer disks into integrated circuit chips involves several steps wherein the wafers are repeatedly processed, stored and transported. Such disks are very delicate and extremely valuable. Therefore, it is vital that they are properly protected throughout the various processing steps to protect from both physical damage and the introduction of contaminants. Wafer carriers are employed to provide the necessary protection for wafers during the manufacturing process. U.S. Pat. Nos. 5,944,194 and 6,216,874 B1 both disclose representative examples of wafer carriers. Both of U.S. Pat. Nos. 5,944,194 and 6,216,874 B1 are herein incorporated by reference.

The manufacturing process for wafers is generally automated. Therefore, it is essential for the wafer carrier to be precisely aligned with respect to production machinery so that the individual disks can be handled by the automated equipment. Preferably, the tolerances between the processing equipment and the wafer disks will be minimal.

Referring to FIG. 1, a wafer carrier or pod 50 is shown disposed on automated wafer processing equipment 52. The wafer carrier 50 has a shell or housing portion 54 comprising bottom 56, front side 58 having an opening 60, and back side 62 opposite opening 60. Carrier 50 also includes a wafer support structure 57, shown in FIG. 5, for supporting wafer disks 64 in a horizontal position. Door 66 is provided for closing opening 60 and sealing with the housing portion 54 to prevent contamination of disks 64.

Referring to FIG. 2, the bottom of the carrier is shown. The bottom 56 provides three pairs of interface contact portions 68, each as shown in FIG. 2a. The contact portions 68 comprise angled surfaces 67 extending from the bottom surface 56 in an approximately equally spaced pattern. The interface portions 68 are commonly referred to as kinematic couplings in the art and are part of a two-coupling pair. The other part of the pair is the three projections 90 as shown in FIG. 5.

Referring to FIG. 3, guide plate 70 may be attached to the bottom of the carrier and have the kinematic coupling 68 molded therein. The guide plate 70 is shown having a carrier side 72, an equipment side 74 opposite the carrier side 72, front side 76 corresponding with carrier front side 58, and backside 78 corresponding with carrier back side 62. Guide plate 70 comprises guide arms 80, sensor pads 82 and guide surfaces 84. The guide surfaces 84 comprise the kinematic couplings 68. Guide arms 80 are shown generally extending from the center of an equilateral triangle to the points of the triangle leaving an angle of 120 degrees between adjacent arms. FIG. 4 shows the carrier 50 with corresponding base plate 70 in alignment with the bottom of the carrier 56.

Referring to FIG. 5, the cooperation of carrier 50 with the automated equipment 52 is shown. The automated processing equipment 52 is provided with a plurality of protrusions or pins 90. The guide plate 70 is provided to the carrier and aligned so that the kinematic couplings 68 are centered above the pins 90. The carrier 50 is placed on the machinery 52 by resting the kinematic couplings 68 upon the pins 90. The pins slide along the angled surfaces 67 until the carrier 50 is centered on the machinery 52. This process allows automated transport means to reliably and repeatably place a wafer carrier 50 on a piece of machinery 52.

The wafer container 50 and base plate 70 for a carrier are both typically comprised of polycarbonate. Polycarbonate materials are commonly used because they provide a combination of ease of moldability and low costs. The pins 90 on the automated machinery 52 are often metal.

The use of polycarbonate as the contact surface for the pins causes the carrier to occasionally fail to center on the kinematic coupling. This problem has been found to be caused by the relatively high co-efficient of friction between the pins and the respective pin contacting surfaces. One possible solution is to form both the carrier and base plate from materials with a co-efficient of friction low enough to avoid the misalignment difficulties. However, such solution is believed to be cost prohibitive and would introduce manufacturing difficulties and added cost. Therefore, there remains a continuing need to provide a kinematic coupling and method for aligning a wafer carrier on automated equipment that overcomes the disadvantages of the prior art.

### SUMMARY OF THE INVENTION

A coupling for aligning wafer carriers as part of an automated manufacturing process may be referred to as a kinematic coupling. The kinematic coupling of the present invention may comprise a wafer carrier or carrier base plate comprising a first material. The base plate or carrier is provided with a contact component comprising a second material having a lower co-efficient of friction than the first material. The contact component may be provided to the base plate or directly to the bottom of a wafer carrier as part of an overmolding, snap-in-place, staking, ultrasonic weld or adhesive operation and may additionally be held in place by mechanical interlocking of the respective components. The method of manufacturing may include providing a contact component comprised of a first material to a carrier component comprised of a second material via one or more of the processes listed above, wherein the second material has a higher coefficient of friction than the first.

It is an object and advantage of particular embodiments of the present invention to overcome certain disadvantages of the prior art.

It is an object and advantage of particular embodiments of the present invention to provide a kinematic coupling with advantageous improved properties.

It is an object and advantage of particular embodiments of the present invention to provide a cost conserving method of manufacturing a kinematic coupling with two different materials.

It is an object and advantage of particular embodiments of the present invention to provide a kinematic coupling of two different materials that resist stress failure.

Additional objects and advantages of particular embodiments of the present invention may be found by those of skill in the art upon review of the figures and detailed descriptions of the invention herein.

### BRIEF DESCRIPTION OF THE FIGURES

FIG. 1 is a perspective view of a wafer carrier engaged with processing equipment according to the prior art.

FIG. 2 is a bottom elevational view of the interface side of a wafer carrier according to the prior art.

FIG. 2a is a detail cutaway view of a cross section of the contact portion of the bottom surface according to the prior art.

FIG. 3 is a perspective view of the carrier side of a guide plate according to the prior art.

FIG. 4 is a bottom elevational view of the interface side of a carrier with attached guide plate according to the prior art.

FIG. 5 is a partial sectional, exploded, elevational view of a wafer carrier having an attached guide plate engaging processing equipment.

FIG. 6 is an exploded perspective view of an insert molded kinematic coupling according to an embodiment of the present invention.

FIG. 7 is a perspective view of an insert according to an embodiment of the present invention.

FIG. 8 is a bottom view of a wafer carrier according to an embodiment of the present invention.

FIG. 9 is an axial cross-sectional view of the interface coupling according to an embodiment of the present invention.

FIG. 10 is a longitudinal cross-sectional view of the interface coupling according to an embodiment of the present invention.

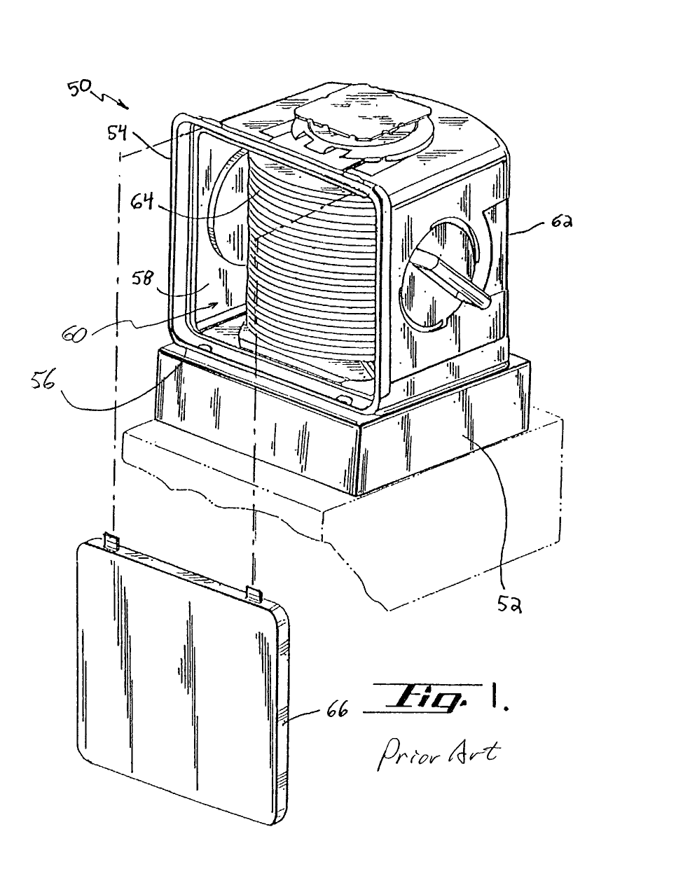

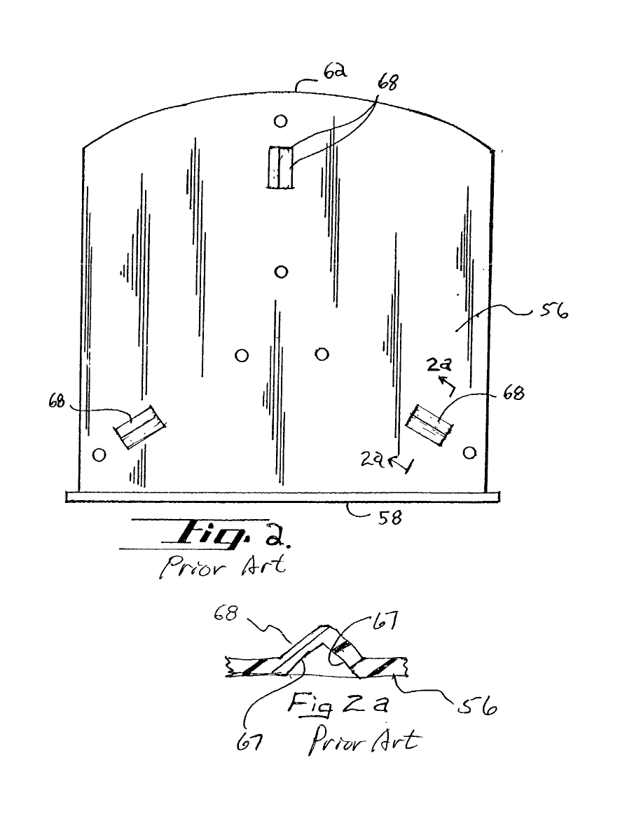

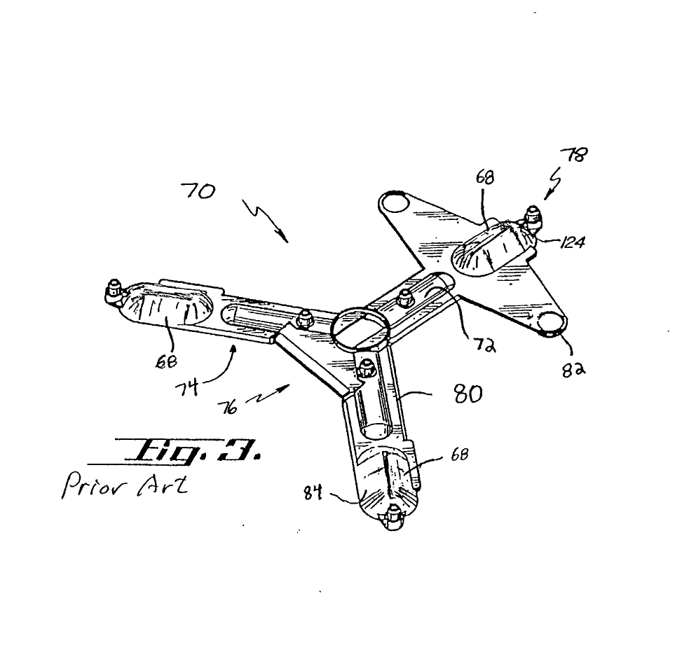

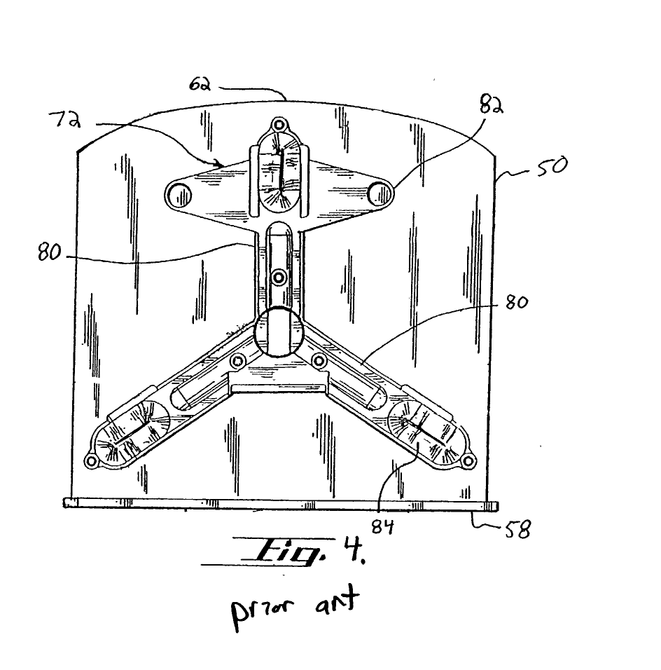

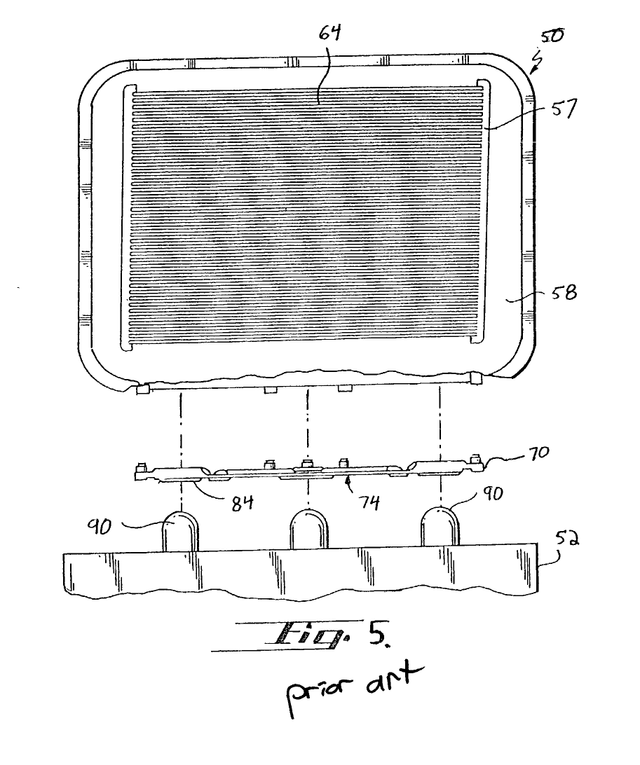

### DETAILED DESCRIPTION OF THE INVENTION

The process of over molding principally involves several steps as discussed in copending U.S. application Ser. No. 09/317,989, filed on May, 25, 1999, entitled “COMPOSITE SUBSTRATE CARRIER” and having the same inventive entity and assignee as the present application, which is hereby incorporated by reference herein. In the first step, a mold is provided for making a first molded piece, such as a kinematic coupling contact component. The contact component is molded and then put into an additional mold or, alternatively, the same mold with a mold insert removed. The second step involves closing the mold with the contact component in place and overmolding the contact component with a second material injected into the mold cavity to form, for example, a wafer carrier pod. The molding process may also be performed in the reverse. In reverse, the wafer carrier pod from the previous example is molded first, and then the contact component is molded as a second step.

The completed composite piece then comprises a wafer carrier pod having a captured contact component. Such method allows the contact component to comprise a contact component having material properties optimized to function as a kinematic coupling-type fitting for use in a fab without significantly compromising the properties, cost or ease of manufacture of the overall carrier.

In particular applications it may be suitable to have the first injection molded component be relatively smaller volumetrically than the second overmolded component. In other applications a first material may be deposited at critical positions in the mold followed by a second over molded material without changing molds and without opening the mold.

Alternatively, in particular applications, the second material does not have to be allowed to solidify. Instead, the two materials may join while both are molten. Such co-injection molding may not offer the same level of precision in locating the interface between the first component and the second component as overmolding; however, it does eliminate the need for the extra mold and added steps including allowing the first component to solidify, removing the component from the mold and placement of the first component in a second mold.

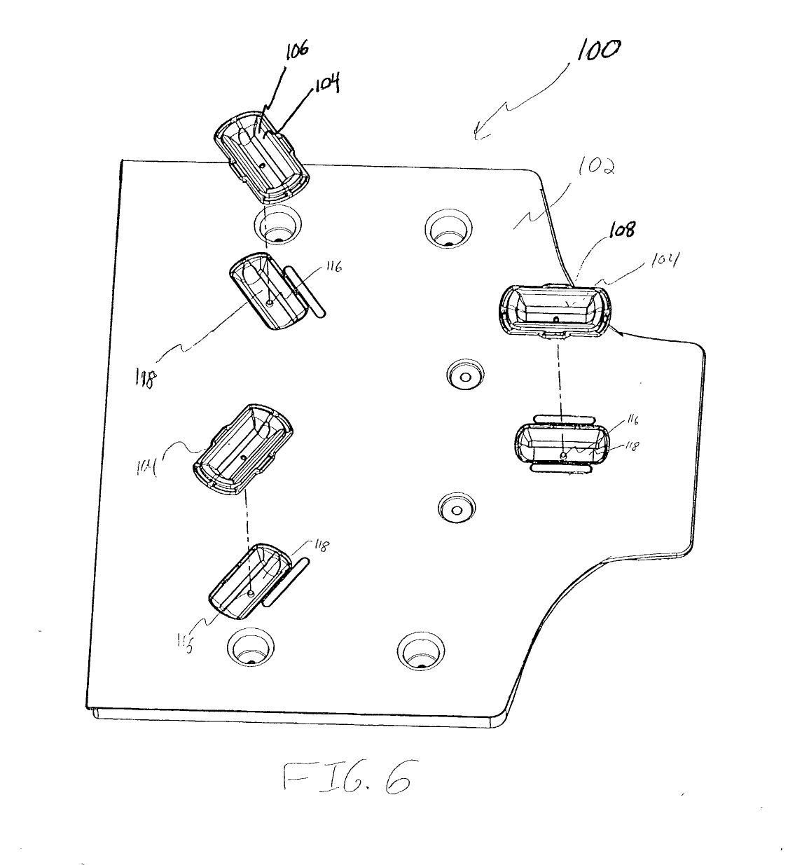

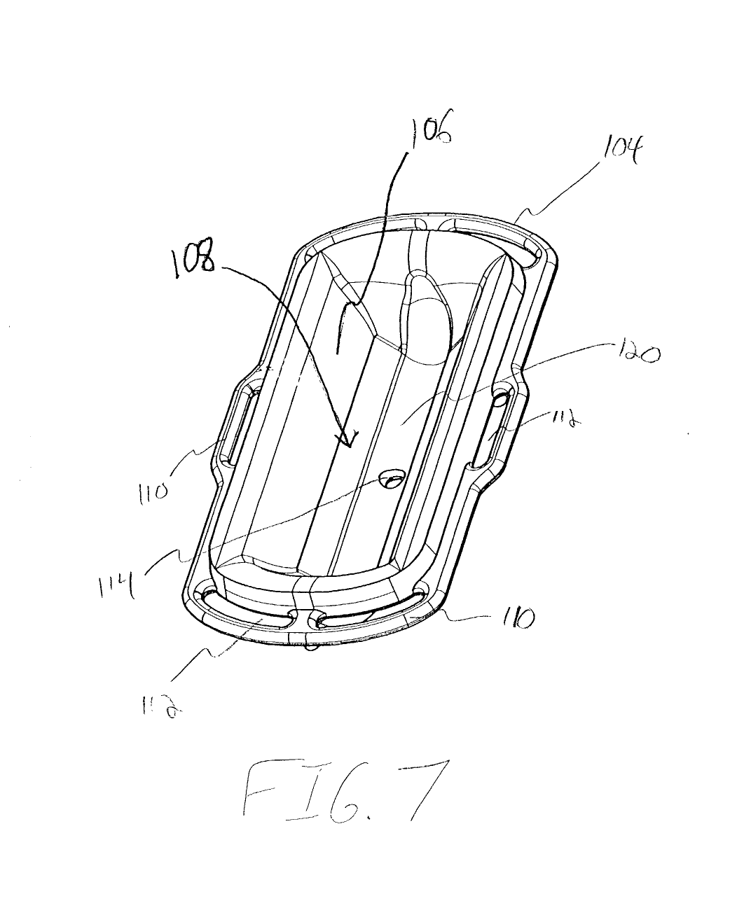

Referring to FIG. 6, the base plate 100 of a wafer carrier comprises a mounting plate 102 and three or more contact components 104. Referring to FIGS. 6 and 7, each contact component 104 preferably comprises an interior surface 108 with a contact surface 106 that may be generally expanded U-shaped or V-shaped in an axial cross section view. The contact surfaces 106 converge as the interior surface 108 deepens. A bore 114 is provided along the apex 120 of the interior surface 108. The contact component 104 may be further provided with a laterally extending rib or extension 110 on a portion or the entire periphery of the contact component 104. The extension 110 may preferably have one or more slots 112 or apertures provided therein for aiding in mechanically locking the contact component 104 to the mounting plate 102.

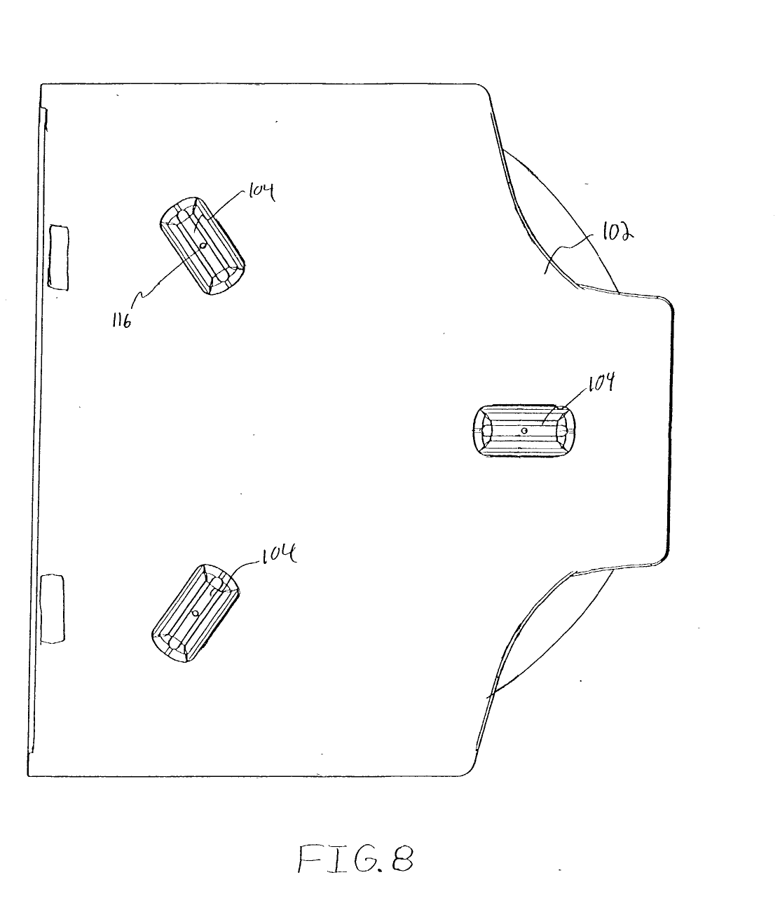

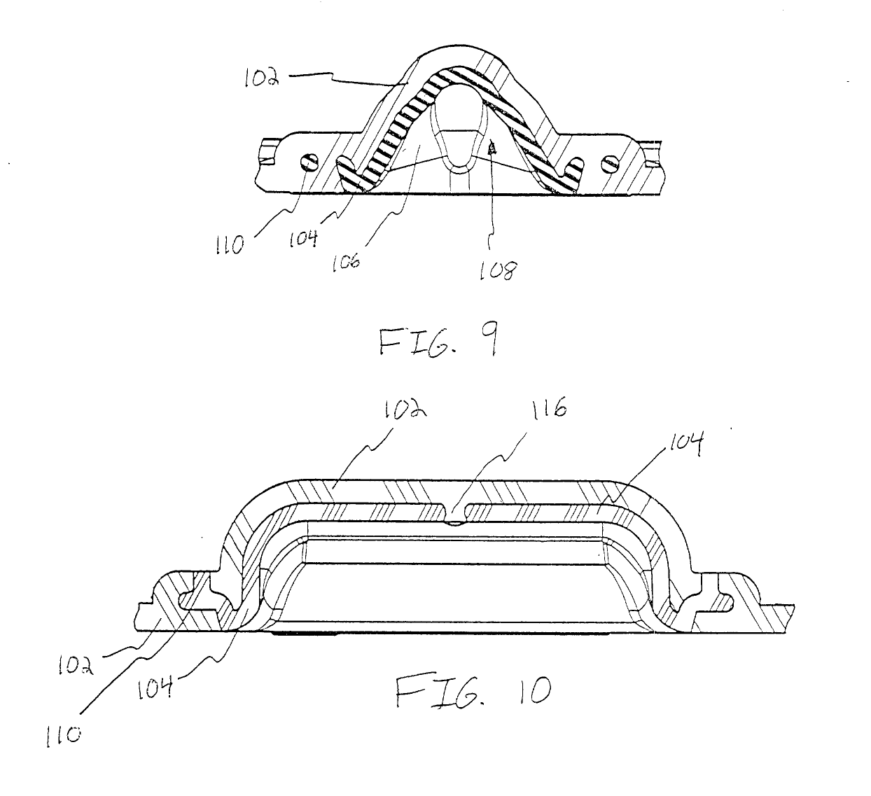

Referring to FIGS. 6, 9 and 10, the mounting plate 102 has three or more recesses 118 corresponding to the number of contact components 104. Each recess 118 is preferably provided with a protrusion 116 configured for cooperating with the bore 114 of a respective contact component 104. Such cooperation aids in securing the contact component 104 within the recess 118. In an alternative embodiment, the contact component 104 can be provided directly to the base of a wafer carrier, rather than to a first mold as part of an overmolding operation, as shown in FIG. 8.

The mounting plate 102, according to a preferred embodiment of the present invention, is comprised of a carbon powder-filled polycarbonate. However, those skilled in the art will recognize that other plastic materials may be employed without departing from the scope of the present invention. The contact components are preferably comprised of carbon fiber (CF) and Polytetrafluoroethylene (PTFE) loaded PolyEtherimide (PEI). The CF is desirable for its conductive properties. The PTFE is desirable due to its low coefficient of friction. PEI adds strength to the CF PTFE composite. Polyetheretherketone (PEEK) may also be used in combination or in the alternative to PEI as the material combination.

CF PTFE PEI has very good abrasion resistance against metals. Moreover, the tribological properties indicate that CF PTFE PEI has substantial uniform microstructures that facilitate seating of the kinematic coupling on the pin-type protrusions of a FAB. Those skilled in the art will recognize that other suitable materials may be employed for the contact components 104 without departing from the spirit and scope of the present invention.

The base plate 100 is preferably formed by way of an overmolding-type process. The contact components 104 are preferably first molded by an injection molding process. Then the completed contact components 104 are provided to a second mold that overmolds the polycarbonate mounting plate 102. The resulting base plate 100 is then comprised of interlocked dissimilar plastics. Alternatively, the mounting plate 102 may be molded first and then the contact component 104 overmolded as a second step without departing from the present invention.

The contact component 104, according to a preferred embodiment, is not held in place by means of a chemical bond, but rather, it is retained by mechanical interlocking means. The mechanical interlocking means is used because it is less prone to stress cracking and is more readily adaptable to differing materials and physical configurations. However, certain embodiments of the present invention may include the use of chemical fastening means as one of the intended types of fastening means.

The mechanical interlocking means comprises extensions 110 with slots 112, bore 114 and protrusion 116. The extensions 110 are disposed within the polycarbonate material of the mounting plate 102. As shown in FIG. 10, the plate surrounds the extensions 110 due to the presence of the slots or apertures 112. This cooperation contributes to the mechanical interlocking. Further mechanical interlocking is provided by the cooperation of the bore 114 in the contact component 104 with the protrusion 116 in the recess 118 of the mounting plate 102. This cooperation is illustrated in FIG. 12. Those of skill in the art will appreciate that other physical manifestations of ribs, extensions, slots, bores, holes and protrusions may be employed on respective portions of the contact component 104 and mounting plate 102 to provide the needed mechanical interlocking function. Additionally, the contact component 104 may be retained by sonic welding, chemically bonding, staking, snapping-in-place or by co-injection molding the two respective components.

Although the present invention has been described with reference to preferred embodiments, workers skilled in the art will recognize that changes may be made in form and detail without departing from the spirit and scope of the invention.

1. A method of providing a kinematic coupling to a wafer carrier, the method comprising the steps of:
providing a contact component comprising a first material, the contact component configured to operably cooperate with kinematic couplings on automated machinery;
placing the contact component in a mold apparatus; and
injecting a second material into the mold to form a wafer carrier component, wherein the contact component is secured to the wafer carrier component and wherein the second material has different characteristics than the first material.

2. The method of claim 1, further comprising the step of molding the contact component of CF PTFE PEI.

3. The method of claim 1, further comprising the step of molding the contact component of CF PTFE PEEK.

4. The method of claim 1, further comprising the step of forming a pair of angled faces in the contact component.

5. The method of claim 1, wherein the second material is a polycarbonate.

6. The method of claim 1, wherein the integral wafer carrier component is a base plate.

7. The method of claim 1, wherein the integral wafer carrier component is a container portion configured to retain semiconductor wafers.

8. The method of claim 1, further comprising the step of mechanically interlocking the contact component to the carrier component.

9. A method of providing a kinematic coupling to a wafer carrier, the method comprising the steps of:
securing a contact component to a wafer carrier component, the contact component comprising a pair of angled faces and formed of a first material, the wafer carrier component comprising of a second material having a different chemical composition than the first material, wherein the contact component is configured to operably cooperate with kinematic coupling projections on automated machinery.

10. The method of claim 9, wherein the step of securing the contact component includes sonically welding the contact component to the carrier component.

11. The method of claim 9, wherein the step of securing the contact component includes chemically bonding the contact component to the carrier component.

12. The method of claim 9, wherein the step of securing the contact component includes staking the contact component to the carrier component.

13. The method of claim 9, wherein the step of securing the contact component includes snapping the contact component in place on the carrier component.

14. A method of providing a kinematic coupling to a wafer carrier, the method comprising the steps of:
mechanically interlocking three kinematic coupling contact components to a wafer carrier component, each contact component comprising a pair of angled faces and formed of a first material, the wafer carrier component comprised of a second material having a different chemical composition than the first material, wherein the contact component is configured to operably cooperate with kinematic coupling projections on automated machinery.

15. The method of claim 14, wherein the mechanical interlocking comprises an extension of the contact component having one or more apertures therein for receiving the second material.

16. The method of claim 14, wherein the contact component comprises an interior surface and a bore therein, the bore configured to mate with a protrusion on the carrier component.

17. A wafer carrier apparatus configured for interfacing with automated machinery, the apparatus comprising:
a wafer carrier comprising a pod having an inside surface, an outside surface and an opening; a wafer support structure provided to the inside surface of the carrier and configured to support semiconductors wafers in a horizontal position; and a fitting configured to align the wafer carrier with the automated machinery, the fitting comprising:
a base plate having three recesses, the base plate comprising a first material;
three contact components configured to be securably received in the three recesses of the base plate, wherein the contact component comprises a second material having a lower coefficient of friction than the first material.

18. The wafer carrier of claim 17, wherein the first material is polycarbonate.

19. The wafer carrier of claim 17, wherein the second material is selected from a group consisting of CF PTFE PEI and CF PTFE PEEK.

20. The wafer carrier of claim 17, wherein the contact component is securably received in the recess by fastening.

21. The wafer carrier of claim 17, wherein the contact component is securably received in the recess by chemically bonding.

22. The wafer carrier of claim 17, wherein the contact component is securably received in the recess by overmolding.

23. The wafer carrier of claim 17, wherein the contact component further comprises a lateral extension having one or more slots therein, the slots configured to aid in securing the contact component into the recess.

24. A wafer carrier apparatus configured for interfacing with automated machinery, the apparatus comprising:
a wafer carrier comprising a pod having an inside surface, an outside surface and an opening; a wafer support structure provided to the inside surface of the carrier and configured to support semiconductors wafers in a horizontal position; and a fitting configured to align the wafer carrier, the fitting comprising:
a contact component integrally provided to the carrier, wherein the carrier comprises a first material and the contact component comprises a second material, the second material having a lower coefficient of friction than the first material.

25. A wafer carrier apparatus comprising:
means for contacting a pin component of a kinematic coupling, said contacting means comprising a first material;
means for carrying semiconductor wafers, said carrying means comprising a second material; and
means for securing said contacting means to said carrying means.

26. The apparatus of claim 25, wherein the carrying means includes a base plate.

27. A method of providing an integral kinematic coupling to a wafer carrier, the method comprising:
co-injection molding a contact component to a wafer carrier component, the contact component comprised of a first material and the wafer carrier component comprised of a second material having a different chemical composition than the first material, wherein the contact component is configured to operably cooperate with automated machinery.

28. A method for securing an automate machinery contacting portion of a kinematic coupling to a base plate of a wafer carrier, the method comprising the steps of:
placing a wafer carrier contact component in a mold, the wafer carrier contact component having a lip extending therearound, the lip including a plurality of recesses therethrough;
injecting a melt flowable material into the mold to form a wafer carrier base plate, the flowable material filling the recesses in the lip of the wafer carrier contact component.

29. A method for securing an automated machinery contacting portion of a kinematic coupling to a base plate of a wafer carrier, the method comprising the steps of:
placing a wafer carrier contact component in a mold, the wafer carrier contact component having a lip extending therearound, the lip including a plurality of recesses therethrough;
injecting a melt flowable material into the mold to form a wafer carrier, the flowable material filling the recesses in the lip of the wafer carrier contact component.
